(19) United States
(12) Patent Application Publication
(10) Pub. No.: US 2020/0143071 A1
(43) Pub. Date: May 7, 2020

(54) DATA SHARING METHOD, DEVICE AND COMPUTER READABLE STORAGE MEDIUM

(71) Applicant: Ping An Technology (Shenzhen) Co., Ltd., Shenzhen, Guandgdong (CN)

(72) Inventor: Leifeng Shao, Shenzhen, Guangdong (CN)

(73) Assignees: Ping An Technology (Shenzhen) Co., Ltd., Shenzhen, Guangdong (CN); Ping An Technology (Shenzhen) Co., Ltd., Shenzhen, Guangdong (CN)

(21) Appl. No.: 16/305,898

(22) PCT Filed: Feb. 11, 2018
(86) PCT No.: PCT/CN2018/076203

§ 371 Date: Nov. 30, 2018

(30) Foreign Application Priority Data
Jul. 31, 2017 (CN) 201710644827.X

(51) Int. Cl. G06F 21/62; G06F 16/953

(52) U.S. Cl. CPC G06F 21/6218; G06F 16/953

(57) ABSTRACT

Disclosed is a data sharing method, which includes the following steps: when a searching request sent from a first client is received, a server acquiring a searching parameter corresponding to the searching request, searching in a preset database based on the searching parameter; verifying the permission of the first client based on the first blacklist information; and when the verification of the permission of the first client is passed, sending the first blacklist information to the first client. The present disclosure also provides a data sharing device and a computer-readable storage medium. The data gathering process of the first client is omitted when sharing the blacklist information, the sharing process of the blacklist information is further simplified, and the sharing efficiency of the blacklist information is improved.

The present application claims the benefit of China Patent Application No. 201710644827.X, filed Jul. 31, 2017, with the State Intellectual Property Office and entitled “DATA SHARING METHOD, DEVICE AND COMPUTER READABLE STORAGE MEDIUM”, the entirety of which is hereby incorporated herein by reference.

### FIELD

The present disclosure generally relates to the technical field of data processing, and more particularly relates to a data sharing method, a data sharing device, and a computer readable storage medium.

### BACKGROUND

Most of enterprises, with the rapid development, store information, such as, a client with bad record in business and his phone number, or a separated employee with bad record in work or quitted due to a unsatisfied salary, in a blacklist information database, so as to facilitate the risk management in the business development.

Currently, for a large group company, each subsidiary corporation of the group company has different blacklist information standard for its own business, and maintains and manages its blacklist information respectively. When a sharing of the blacklist information is needed among the subsidiary corporations, the subsidiary corporation having the demand of sharing can only share the blacklist information by gathering information data from the sharing subsidiary corporation. The process for sharing the blacklist information is complex and inefficiency.

### SUMMARY

It is therefore one main object of this disclosure to provide a data sharing method, a data sharing device, and a computer-readable storage medium, aiming to solve the technical problem of that in the existing technology the blacklist information sharing process is complex and inefficiency.

In order to achieve the above object, the data sharing method proposed by this disclosure includes:

when a searching request sent from a first client is received, a server acquiring a searching parameter corresponding to the searching request, and when a searching instruction triggered from an information sharing interface displayed by the first client is received, the first client sending the searching request to the server;

the server verifying the permission of the first client based on the first blacklist information; and

the server searching in a preset database based on the searching parameter, to obtain the first blacklist information corresponding to the searching parameter;

when the verification of the permission of the first client being passed, the server sending the first blacklist information to the first client.

In addition, in order to achieve the above object, the present disclosure also provides a data sharing device, which includes:

an acquiring module, configured to, when a searching request sent from a first client is received, acquire a searching parameter corresponding to the searching request, wherein, when a searching instruction triggered from an information sharing interface displayed by the first client is received, the first client sends the searching request to the server;

a searching module, configured to search in a preset database based on the searching parameter, to obtain a first blacklist information corresponding to the searching parameter;

a verifying module, configured to verify the permission of the first client based on the first blacklist information; and

a first sending module, configured to send the first blacklist information to the first client when the verification of the permission of the first client is passed.

In addition, in order to achieve the above object, the present disclosure also provides a data sharing device, which includes: a memory, a processor, and a data sharing program stored in the memory and operated by the processor, the data sharing program performs the steps in any one of the data sharing methods when is executed by the processor.

In addition, in order to achieve the above object, the present disclosure also provides a computer-readable storage medium, the computer-readable storage medium stores a data sharing program, the data sharing program performs the steps in any one of the data sharing methods when is executed by a processor.

The data gathering process of the first client is omitted when sharing the blacklist information, the sharing process of the blacklist information is further simplified, and the sharing efficiency of the blacklist information is improved, at the same time, it can be ensured that, when the first blacklist information is sent to the first client, the first client has the permission for consulting the first blacklist information by verifying the permission of the first client, so that the standardized management of the blacklist information is realized, and further improving the sharing efficiency of the blacklist information.

### BRIEF DESCRIPTION OF THE DRAWINGS

FIG. 1 is a structure diagram of the terminal of the data sharing device in hardware operating environment of the present disclosure according to an exemplary embodiment;

FIG. 2 is a flow chart of the data sharing method of the present disclosure according to the first exemplary embodiment.

The realization of the aim, functional characteristics, advantages of the present disclosure are further described specifically with reference to the accompanying drawings and embodiments.

### DETAILED DESCRIPTION

It is to be understood that, the described embodiments are only some exemplary embodiments of the present disclosure, and the present disclosure is not limited to such embodiments.

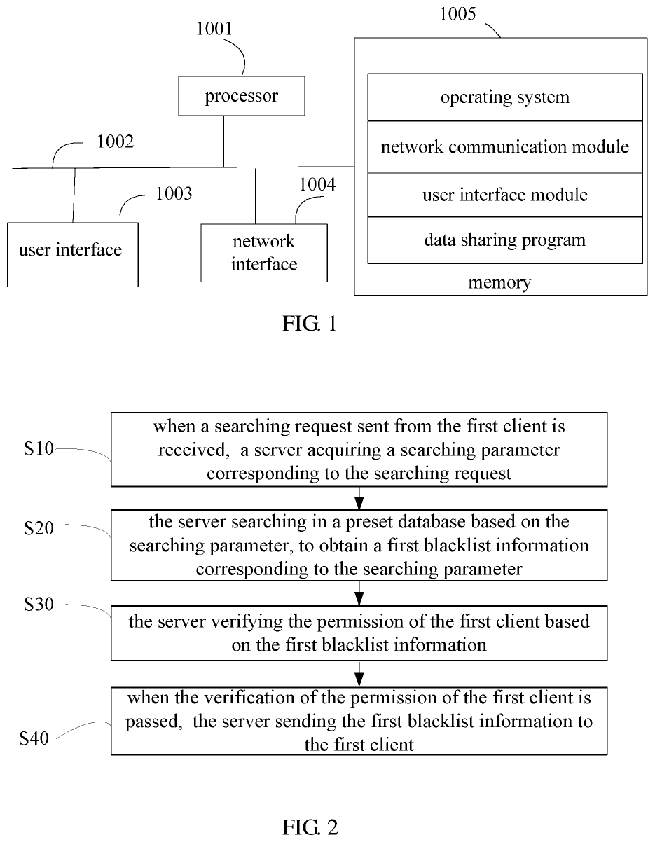

FIG. 1 is a structure diagram of terminal of the data sharing device in hardware operating environment of the present disclosure according to an exemplary embodiment;

The terminal of the present disclosure in the exemplary embodiment can be a personal computer (PC). Referring to FIG. 1, the terminal includes: a processor 1001, such as a central processing unit (CPU), a network interface 1004, a user interface 1003, a memory 1005, and a communication bus 1002. The communication bus 1002 is configured to realize the connecting and communicating among the above components. The user interface 1003 can include a display, an input unit, such as a keyboard, selectively, the user interface 1003 can also include a standard wired interface, wireless interface. Selectively, the network interface 1004 can include a standard wired interface, wireless interface (such as, a WI-FI interface). The memory 1005 can be a high speed RAM memory, or a non-volatile memory, such as, a magnetic disc memory. Selectively, the memory 1005 can be a storage device which is independent of the processor 1001.

Selectively, the terminal can also include a camera, a radio frequency (RF) circuit, a sensor, an audio circuit, a WiFi module, and so on. The sensor can be an optical sensor, a motion sensor, and other sensors. In detail, the optical sensor can include an ambient light sensor and a proximity sensor, where the ambient light sensor can adjust the brightness of the display screen according to the brightness of the ambient light, the proximity sensor can be configured to turn off the display screen and/or backlight when the mobile terminal moves to the ear. A gravity acceleration sensor, as one kind of the motion sensor, can detect the magnitudes of accelerations in all directions (there are normally three axis directions), and can detect the magnitude of gravity and the direction of gravity when resting, and can be configured to recognize the application of posture of the mobile terminal (such as, the switching between portrait and landscape, related games, magnetometer for calibrating posture, and be configured to recognize related function according to vibrating (such as, pedometer, knocking), and so on; of course, the mobile terminal can also be configured with a gyroscope, a barometer, a hygrometer, a thermometer, an IR infrared sensor, and other sensors, no need to repeat again.

The persons skilled in the art can understand that, the structure of terminal shown in FIG. 1 cannot be used for limiting the terminal of the present disclosure, and can include more or less parts, or include combination of some of the parts, or include different configuration of parts.

Referring to FIG. 1, the memory 1005, which is defined as a computer storage medium, can include an operating system, a network communication module, a user interface module and a data sharing program.

In the terminal as shown in FIG. 1, the network interface 1004 is mainly configured to connect with a backend server, and perform data communication with the backend server; the user interface 1003 is mainly configured to connect with a client (user side), and perform data communication with the client; while the processor 1001 is configured to call the data sharing program stored in the memory 1005 and perform the data sharing method provided by the exemplary embodiment of the present disclosure.

The present disclosure further provides a data sharing method, referring to FIG. 2, FIG. 2 is a flow chart of the data sharing method of the present disclosure according to the first exemplary embodiment.

In the exemplary embodiment, the data sharing device includes:

Step S10, when a searching request sent from a first client is received, a server acquiring a searching parameter corresponding to the searching request, when a searching instruction triggered from an information sharing interface displayed by the first client is received, the first client sending the searching request to the server;

The first client refers to a client which currently sends out the searching request, and can be one of the clients in the server, for example, a group company has multiple subsidiary corporations, the clients of all the subsidiary corporations which are communicated with the server can send the searching request of the blacklist information to the server, the client of any one of the subsidiary corporations when sending the searching request is defined as the first client by the server.

In the exemplary embodiment, the search parameter includes shielding channel, shielding category, shielding duration, and shielding reason, and so on, the information sharing interface is a web page presented to user by the server, the information sharing interface can be presented on all of the clients corresponding to the server, customer is able to browse or initiate a searching function on the information sharing interface. Specifically, customer can input searching parameter in the information sharing interface, and then click the searching button or option, etc, so as to trigger the searching instruction, when the first client receives the searching instruction triggered based on the searching button or option, the first client sends the searching request to the server; when the server receives the searching request sent from the first client, the server acquires the searching parameter corresponding to the searching request sent from the first client. Such as, when a subsidiary company A needs to acquires a client's phone blacklist information with a shielding duration of three years from the group blacklist information database due to the business requirement, the searching parameter inputted by a staff of subsidiary company A in the information sharing interface displayed by the corresponding company client is the shielding duration with the value of three years, and the staff clicks the searching button to trigger the searching instruction, when the first client receives the searching instruction triggered based on the searching button, sends the searching request to the server, when the searching request includes the searching parameter, the server can analyse the searching request when the searching request is received, so as to obtain the searching parameter corresponding to the searching request, in detail, the first client can generate the searching request according to a preset format, as such the searching request includes the searching parameter; when the server receives the searching request, analyses the searching request according to the same preset format, for obtaining the searching parameter in the searching request; or, when the searching request does not include the searching parameter, the server sends the acquiring request corresponding to the searching request to the first client, the first client sends the acquired searching parameter to the server. And, through clicking the interface button on the information sharing interface, the staff can enter into the multi-condition searching interface to input multiple searching parameters. For example, according to the information tip of the information sharing interface, the shielding category is entered as a phone shield, the shielding duration is entered as 5 years, and the shielding reason as that a similar product has been purchased.

Preferably, customer can select the searching parameter according to the information tip on the information sharing interface, and then can click the searching button or option, etc, to trigger the searching instruction, when the first client receives the searching instruction triggered by the searching button or option, sends the searching request to the server, when the server receives the searching request sent from the first client, acquires the searching parameter corresponding to the searching request sent from the first client. Of course, customer can click the interface button on the information sharing interface to inter into the multi-conditions searching interface, and then select multiple searching parameters according to the tip of the interface.

Step S20, the server searching in a preset database based on the searching parameter, to obtain a first blacklist information corresponding to the searching parameter;

In the exemplary embodiment, when the server acquires the searching parameter, searches in the preset database according to the searching parameter, to obtain the first blacklist information corresponding to the searching parameter. In detail, the first blacklist information can be divided into several categories: shielding source, source interface, shielding channel, shielding category, shielding duration, and shielding reason, etc, the first blacklist information is stored in the preset database according to the categories, and the blacklist information having the same category is stored together; the searching parameter includes shielding source, source interface, shielding channel, shielding category, shielding duration, and shielding reason, etc, when the server acquires the searching parameter sent from the first client, the server directly searches in accordance with the searching parameter in the preset database according to the category, to obtain the first blacklist information corresponding to the searching parameter, or taking the searching parameter of the server as the key word, the server searches the first blacklist information containing the key word in the blacklist information in the preset server.

The preset database includes a group remote phone blacklist information database and a group remote seat blacklist information database, etc, the first blacklist information includes seat blacklist information, and phone blacklist information, etc. The seat blacklist information includes information of staff who is quitted or dismissed due of undisciplined violation, information of staff who is quitted or dismissed due of absenteeism, information of staff who is eliminated due of assessment or basic law, information of staff who is dismissed by the company, information of staff who is dismissed due of a fake ID or false credentials, information of staff who is quitted or dismissed due of involving in criminal or civil cases, information of staff who is quitted or dismissed due of leaking customer information of the company, information of staff who is normally quitted due of underpay, etc, the phone blacklist information refers to phone number information which is invalid in the company business or should be tentatively shielded, the phone blacklist information includes phone number information of a customer who has already bought the similar product, phone number information of a customer who abuses, phone number information of a customer who refuses to be called again, phone number information which is shielded under the requirement of monitoring platform, phone number information of a customer who has strong complaint tendency, phone number information of competitor, phone number information of journalist, phone number information of leader, phone number information of agency, phone number information of salesman, etc.

Step S30, the server verifying the permission of the first client based on the first blacklist information;

In the exemplary embodiment, the open permission of the first blacklist information is set at the sharing client corresponding to the first blacklist information, a first identification information of the first client allowing to view the first blacklist information can be inputted into or selected from the authorization setting interface, all of the first identification information form a preset authorization information. Furthermore, the server acquires the preset authorization information corresponding to the first blacklist information and the first identification information corresponding to the first client first, and judges whether the preset authorization information contains the first identification information corresponding to the first client, when the preset authorization information contains the first identification information, it means that the first client is passed the permission validation, and has the permission of consulting the first blacklist information.

Step S40, when the verification of the permission of the first client is passed, the server sending the first blacklist information to the first client.

In the exemplary embodiment, when the first client is passed the permission validation, that is, the preset authorization information corresponding to the first blacklist information contains the first identification information corresponding to the first client, the server sends the first blacklist information to the first client.

In the data sharing method provided by the exemplary embodiment, when the searching request sent from the first client is received, the server acquires the searching parameter corresponding to the searching request, and then the server searches in the preset database based on the searching parameter, so as to obtain the first blacklist information corresponding to the searching parameter, then the permission of the first client is verified based on the first blacklist information, finally when the verification of the permission of the first client is passed; the server sends the first blacklist information to the first client. As the server directly sends the first blacklist information to the first client, the data gathering process of the first client is omitted when sharing the blacklist information, then the sharing process of the blacklist information is simplified, and the sharing efficiency of the blacklist information is improved, at the same time, it can be ensured that, when the first blacklist information is sent to the first client, the first client has the permission for consulting the first blacklist information by verifying the permission of the first client, so that the standardized management of the blacklist information is realized, and further improving the sharing efficiency of the blacklist information.

Based on the first exemplary embodiment, the data sharing method according to the second exemplary embodiment is provided, in the exemplary embodiment, step S30 includes:

S31, the server acquiring the first identification information of the first client and preset authorization information corresponding to the first blacklist information;

In the exemplary embodiment, the first identification information of the first client includes subsidiary corporation's name or subsidiary corporation's company code, etc, the preset authorization information includes that one subsidiary corporation can consulting other subsidiary corporation's name or company code contained in the blacklist information of the company. Among them, the preset authorization information is set by a technicist of the subsidiary corporation corresponding to the sharing client, in detail, when the technicist uploads the first blacklist, the technicist inputs the identification information corresponding to all the subsidiary corporations allowing to consulting the first blacklist into the authorization setting interface, or selects the identification information corresponding to all the subsidiary corporations allowing to consulting the first blacklist from the authorization setting interface, that is, the sharing client allows to consult the company name or company code of all of the subsidiary corporations in the first blacklist information.

S32, verifying the permission of the first client based on the first identification information and the preset authorization information.

In the exemplary embodiment, verifying the permission of the first client refers to comparing the identification information of the first client with the preset authorization information corresponding to the first blacklist information, when the preset authorization information corresponding to the first blacklist information contains the identification information of the first client, it means that the first client is passed the permission validation, and the server sends the first blacklist information to the first client.

In the data sharing method of the present disclosure, the first identification information of the first client and the preset authorization information corresponding to the first blacklist information are acquired by the server, and then the server verifies the permission of the first client based on the first identification information and the preset authorization information; the permission of the first client can be precisely verified according to the first identification information and the preset authorization information, and the verifying process is simple and valid, such further improving the sharing efficiency of the information.

Based on the first exemplary embodiment, the data sharing method according to the third exemplary embodiment is provided, in the exemplary embodiment, after step S30, the data sharing method further includes:

step S50, when the verification of the permission of the first client is not passed, the server sending an authorization request to a sharing client corresponding to the first blacklist information;

In the exemplary embodiment, when the verification of the permission of the first client is not passed, the server sends the authorization request to the sharing client corresponding to the first blacklist information. When the sharing client receives the authorization request, the sharing client can agree to view information, or refuse to view information according to the authorization request, the sharing client can immediately make a choice, or does not make a choice for now, such as, as subsidiary corporation A does not has the permission of consulting the blacklist information of subsidiary corporation B, while after subsidiary corporation A communicates with subsidiary corporation B, subsidiary corporation B agrees subsidiary corporation A to consult the blacklist information of subsidiary corporation B, and the technicist of subsidiary corporation B can select to consult the information according to the authorization request.

Step S60, when an agreeing to view message fed back from the sharing client based on the authorization request is received, the server sending the first blacklist information to the first client.

In the exemplary embodiment, when the first client does not have the permissions for consulting, the server sends the authorization request to the sharing client, user of the sharing client can make a choice to agree to view the information according to the authorization request, the sharing client sends the agree to view message to the server, when the server receives the agree to view message fed back from the sharing client, sends the acquired first blacklist information to the first client.

In the data sharing method provided by the exemplary embodiment, when the verification of the permission of the first client is not passed, the server sends the authorization request to the sharing client corresponding to the first blacklist information, and then when the server receives the agree to view message fed back by the sharing client based on the authorization request, the server sends the first blacklist information to the first client; the server automatically sends the authorization request to the sharing client, as such the permission for the first client is realized, the authorization process for permitting the first client to consult is simple, further improving the efficiency of data sharing.

Based on the third exemplary embodiment, the data sharing method according to the fourth exemplary embodiment is provided, in the exemplary embodiment, step S50 includes:

Step S51, when the verification of the permission of the first client is not passed, the server pushing an authorization selection interface to the first client, and, when an authorization instruction triggered by the authorization selection interface is received, the first client sending the authorization instruction to the server; and

In the exemplary embodiment, the authorization instruction includes requesting to authorize or refusing to authorize, when the verification of the permission of the first client is not passed, the server pushes the authorization selection interface to the first client, user can click the button of requesting to authorize or the button of refusing to authorize at the authorization interface, to trigger the authorization instruction, the first client sends the authorization instruction to the server. In detail, when the authorization instruction triggered by the authorization selection interface by user is requesting to authorize, and when the first client receives the authorization instruction, the first client sends the authorization instruction to the server, the server sends the authorization request to the sharing client according to the received authorization instruction; when the authorization instruction triggered by the authorization selection interface by user is refusing to authorize, and when the first client receives the authorization instruction, the first client sends the authorization instruction to the server, the server acquires the instruction message of refusing to authorize fed back from the first client waiving according to the received the authorization instruction, at the same time, in order to keep the access record, the server automatically acquires and stores the first identification information of the first client and the preset authorization information of the first blacklist information, and then sends the first identification information to the sharing client corresponding to the first blacklist information.

Step S52, when the authorization instruction sent from the first client is received, the server sending the authorization request to the sharing client based on the authorization instruction.

In the exemplary embodiment, the authorization request includes the first identification information corresponding to the first client and the first blacklist information, and so on, the first client sends the authorization instruction to the server, when the server receives the authorization instruction, sends the authorization instruction to the sharing client, the technicist of the subsidiary corporation corresponding to the sharing client can know that the subsidiary corporation corresponding to the first client wants to acquire the first blacklist information from the subsidiary corporation corresponding to the sharing client, according to the first identification information and the first blacklist information contained in the authorization request.

In the data sharing method provided by the exemplary embodiment, when the verification of the permission of the first client is not passed, the server pushes the authorization selection interface to the first client, when the authorization instruction triggered by the authorization selection interface is received, the first client sends the authorization instruction to the server, then when the server receives the authorization instruction sent from the first client, the server sends the authorization request based on the authorization instruction to the sharing client; it can be ensured that the first client can send the authorization request under the condition of keeping consulting by sending the authorization request according to the authorization instruction, further improving the efficiency of data sharing.

Based on the third exemplary embodiment, the data sharing method according to the fifth exemplary embodiment is provided, in the exemplary embodiment, after step S50, the data sharing method further includes:

Step S70, when a refusing to view message fed back from sharing client based on the authorization request, the server sending the refusing to view message to the first client is received; and

In the exemplary embodiment, when the user of the sharing client makes a choice of refusing to view the message, the sharing client sends the refusing to view message to the server, the server receives the refusing to view message fed back from the sharing client, the server sends the refusing to view message to the first client.

Step S80, the server acquiring the first identification information of the first client, the second identification information of the sharing client, a sending time corresponding to the searching request, and a feedback time corresponding to the refusing to view message; and

In the exemplary embodiment, when the refusing to view the message fed back from the sharing client and based on the authorization request is received, the server sends the refusing to view message to the first client, and then acquires the first identification information of the first client, the second identification information of the sharing client, the sending time corresponding to the searching request and the feedback time corresponding to the refusing to view message. And, the first identification information includes company name or company code of the subsidiary corporation corresponding to the first client, etc, the second identification information includes company name or company code of the subsidiary corporation corresponding to the sharing client, etc.

Step S90, the server associating and storing the first identification information, the second identification information, the sending time, and the feedback time.

In the exemplary embodiment, the sending time refers to the timing of that, when inputting searching parameter into or selecting searching parameter from the information sharing interface, the first client receives the searching instruction from the sharing interface, the first client simultaneously sends the searching request to the server, the feedback time refers to the timing of that the server acquires the refusing to view the message, when the sharing client corresponding to the first blacklist information receives the authorization request sent from the server, the sharing client corresponding to the first blacklist information refuses to view the message. The first identification information of the first client corresponding to the sending time and the feedback time, and the second identification information corresponding to the sharing client are both stored in the database.

In the data sharing method provided by the exemplary embodiment, when the refusing to view message fed back from the sharing client based on the authorization request is received, the server sends the refusing to view message to the first client, then the server acquires the first identification information of the first client, the second identification information of the sharing client, the sending time corresponding to the searching request, and the feedback time corresponding to the refusing to view message, finally the server associates and stores the first identification information, the second identification information, the sending time and the feedback time; associating and storing the above information can facilitate user to consult and search the sharing information, such improving the transmitting efficiency of the information and improving the maintaining efficiency of maintenance person.

Based on the first exemplary embodiment, the data sharing method according to the sixth exemplary embodiment is provided, in the exemplary embodiment, the data sharing method further includes:

Step S100, when an uploading request sent from the second client is received, the server acquiring the second blacklist information corresponding to the uploading request and the third identification information corresponding to the second client;

And the second client refers to the client currently sending the uploading request of the blacklist information, which can be one of the clients in the server, such as, a group company has multiple subsidiary corporations, the clients of all the subsidiary corporations which are communicated with the server can send the uploading request of the blacklist information to the server, the client of any one of the subsidiary corporations when sending the uploading request is defined as the second client by the server. Normally, as one client cannot send the searching request and the uploading request simultaneously, so that, the first client is different from the second client.

In the exemplary embodiment, when the server receives the uploading request sent from the second client, acquires the second blacklist information corresponding to the uploading request and the third identification information corresponding to the second client. In detail, the black information corresponding to each of the subsidiary corporations is stored in corresponding business system, such as a property risk ITS system, a life insurance ITS system, etc, the blacklist information can be stored in the system of each subsidiary corporation by manually inputting or automatically adding the blacklist information. In detail, in the electric marketing industry, the incorrect personal information, or the incorrect phone number information, such as incorrect phone number, etc, can be manually inputted in or automatically added in the business system of the corporation, or when selling products, the phone number information of customer who has performed the verbal abuse can be manually inputted in or automatically added in the business system of the corporation, this kind of phone number information can be defined as the phone blacklist information. Furthermore, in each of the corporations, the staff information, such as, illegality, absenteeism, false identification when entering, eliminated through an assessment, quitted due to the low salary, etc, can be manually inputted in or automatically added in the business system of the corporation, this kind of the staff information can be defined as the seat blacklist information, the second client corresponding to each subsidiary corporation system sends the uploading request to the server, when the server receives the uploading request sent from the second client, acquires the second blacklist information corresponding to the uploading request and the third identification information corresponding to the second client, the third identification information includes name, code, and product of the subsidiary corporation, etc.

Furthermore, when the technicist of each subsidiary corporation uploads the second blacklist information through the second client, the technicist can set the preset authorization information corresponding to the second blacklist information, that is, the technicist can set the identification information of allowing other subsidiary corporations to consult the second blacklist information, in detail, the company name or code, etc, in the second blacklist information which are allowed to be consulted by the other subsidiary corporations, can be inputted into or selected from the authorization setting interface by the technicist.

Step S110, the server associating and storing the second blacklist information and the third identification information;

In the exemplary embodiment, the second blacklist information uploaded by the second client and the third identification information corresponding to the second client are stored in the preset database. And, the second blacklist information includes the attribute information and the content information of the second blacklist information. The attribute information includes information name, uploading time, information category, etc, the content information includes the detail content contained in the second blacklist information, such as, the content information of the phone blacklist information includes the specific phone number, the attribution of the phone number, the name of the person who owns the phone number, reason for being blacklisted, etc; the content information of the seat blacklist information includes name, age, and position of the leaving staff, and reason for being blacklisted in the seat blacklist information, etc.

Furthermore, the third identification information includes the company name, company code, and company product of each subsidiary corporation, etc. The third identification information and the second blacklist information are both uploaded by the second client, when the server found the second blacklist information, the server also found the third identification information corresponding to the second client which has uploaded the second blacklist information. Such as, when phone blacklist information is found by the server, the company code and company name, etc, of the subsidiary corporation which has uploaded the phone blacklist information has also been found.

Step S120, the server updating the information sharing interface according to attribute information of the second blacklist information and the third identification information, and sending the updated information sharing interface to a preset client, for displaying the received information sharing interface by the preset client.

And, the displayed information includes the attribute information of the second blacklist information and the third identification information corresponding to the second client, and so on, that is, the category, the uploading time, the name of second blacklist information, etc, are displayed, and the company name, the company code, etc, of the subsidiary corporation corresponding to the second client are also displayed.

In the exemplary embodiment, the server can display the attribute information of the uploaded second blacklist information on the information sharing interface according to the uploading order, can also display the attribute information of the uploaded second blacklist information on the information sharing interface according to the pre-assigned locations. Taking a group company having multiple subsidiary corporations as an example, the parent company of the group company has the management authority of the server, the pre-assigned locations refer to the areas of the subsidiary corporations corresponding to the pending information. Preferably, the server can leave pre-assigned location on information sharing interface to each subsidiary corporation, when one of the subsidiary corporations completes loading information, the server will arrange the information with the other relevant information together on the display page according to the corresponding location of the subsidiary corporation owned by the second client, the information displayed on the page includes the attribute information of the second blacklist information and the third identification information corresponding to the second client.

In the data sharing method in the exemplary embodiment, when the uploading request sent from the second client is received, the second blacklist information corresponding to the uploading request and the third identification information are acquired, then the second blacklist information and the third identification information are associated and stored, finally the data sharing interface is updated based on the attribute information of the second blacklist information and the third identification information, and the updated data sharing interface is sent to the preset client, for displaying the received data sharing interface by the preset client; customer can clearly know the attribute information of the blacklist information and the third identification information, and customer can easily consult the attribute information of the blacklist information by displaying the attribute information of the second blacklist information on the data sharing interface, which facilitating the searching and accurately acquiring the data.

Based on the sixth exemplary embodiment, the data sharing method according to the seventh exemplary embodiment is provided, in the exemplary embodiment, step S110 includes:

Step S111, the server classifying the second blacklist information according to a preset rule; and

In the exemplary embodiment, the preset rule includes classifying and storing the information in the database according to shielding channel, shielding category, shielding duration, and shielding reason, etc, the shielding channel includes property insurance, life insurance, consulting and insurance regulatory commission, etc, the shielding channel includes a whole series of shielding, property insurance, and life insurance, etc, the shielding duration includes permanent shielding, five yeas, three years, two years, etc, the shielding reason include a customer who has strong complaint tendency, peer shielding, shielding requirement of monitoring platform, etc. In detail, the information content in the second blacklist information includes shielding channel, shielding category, shielding duration, and shielding reason, the server classifies the blacklist information according to the preset rule, such as, the phone blacklist information with a duration of three years is categorized, and then count and ranked, so as to be stored in the preset database. Of course, one blacklist information can be categorized according to different preset rules, and then can be stored with the blacklist information having different categories in the preset database respectively, such as, one blacklist information can be selected to the category of property insurance according to the shield channel, and can also be selected to the shielding duration with the value of three years according to the shielding duration.

Step S112, associating and storing the classified second blacklist information and the third identification information.

In the exemplary embodiment, the blacklist information after being categorized is count and ranked according to different types, the second blacklist information after being categorized and the third identification information corresponding to the second client are stored together, so that when the second blacklist information is acquired, the third identification information corresponding to the second client are acquired simultaneously.

In the data sharing method provided by the exemplary embodiment, the second blacklist information is categorized according to the preset rule, then the second blacklist information after being categorized and the third identification are associated and stored; categorizing the blacklist information can make the searching of the blacklist information much faster, and improve the accuracy and rapidity of acquiring the data, at the same time, the associating and storing operation can facilitate user to search and consult the sharing information, for improving the transmission efficiency of sharing data.

Based on the above exemplary embodiment, the data sharing method according to the eighth exemplary embodiment is provided, in the exemplary embodiment, the blacklist information includes the seat blacklist information, the data sharing method further includes:

Step S130, the server periodically acquiring a resume information received by preset client in a preset time period;

In the exemplary embodiment, the server acquires the resume information sent from the client in the preset time period, or, periodically acquires the resume information acquired by the preset client from a previous acquiring time to the present moment, at this time, the server is communicated with the preset client, when the server acquires the resume information sent from the preset client, the server ends the communication with the preset client, the information in the resume includes name, sex, age, graduation school, household registration, family members, work experience, etc.

And, the preset time period can be reasonably adjusted according to the requirement.

Step S140, the server matching a preset parameter in the resume information to the seat blacklist information, to acquire the blacklist information in the seat blacklist information matched to the preset parameter; and

In the exemplary embodiment, the preset parameter includes name, sex, age, graduation school, household registration, family members, etc, in the resume, the content in the seat blacklist information includes name, sex, age, graduation school, household registration, family members, reasons for leaving, years of working, years of leaving, etc, of separating employee. The server matches the information in the resume information to the seat blacklist information. In detail, the matching process can be conducted according to a preset order, such as, when the names contained in parts of resumes are the same with the names contained in parts of the seat blacklist information, the server selects the parts of the resumes and the parts of the seat blacklist information, and then the server continues to match the parts of the resumes to the parts of the seat blacklist information according to sex, age, graduation school, household registration, etc, and finally the server selects the matched blacklist information and the resume information corresponding to the blacklist information. And, the preset parameter and the matching order can be set by the technician, the technician can input the preset parameter in the preset parameter setting interface in order, or select the preset parameter from the preset parameter setting interface, such as, name, age, sex, graduation school, household registration, etc.

Step S150, the server sending the blacklist information, and the resume information corresponding to the blacklist information to the preset client corresponding to the blacklist information.

In the exemplary embodiment, after the server acquires the blacklist information in the seat blacklist information matched to the preset parameter, the server sends the blacklist information and the resume information corresponding to the blacklist information to the preset client corresponding to the blacklist information. In the seat blacklist information, when the multiple blacklist information respectively match with the multiple resumes, if there is a one-to-one correlation between the blacklist information and the resume, the server sends each resume information and the blacklist information corresponding to the resume information to the preset client corresponding to the resume information respectively, such as, the resume information 1 matches with the blacklist information 1, the resume information 2 matches with the blacklist information 2, the server sends the resume information 1 and the blacklist information 1 to the preset client corresponding to the resume information 1, and sends the resume information 2 and the blacklist information 2 to the preset client corresponding to the resume information 2; when multiple blacklist information correspond to one resume, the server sends the resume information and the multiple blacklist information to the preset client corresponding to the resume, when one blacklist information corresponds to multiple resumes, the server sends the blacklist information and the multiple resumes to the preset client corresponding to the multiple resumes.

In the data sharing method provided by the exemplary embodiment, the server periodically acquires resume information received by preset client in a preset time period, and then the server matches a preset parameter in the resume information to the seat blacklist information, for acquiring the blacklist information in the seat blacklist information matched to the preset parameter; and finally the blacklist information, and the resume information corresponding to the blacklist information are sent to the preset client corresponding to the blacklist information; periodically acquiring resume information can avoid to transmit data in real time, and reduce the data processing pressure of the server, and improve the data sharing efficiency, at the same time, matching the information in the resume information to the seat blacklist information can effectively extract seat blacklist information, for comprehensively understanding and consulting the result information, further improving the quality of recruits.

In addition, in order to achieve the above object, the present disclosure further provides a data operating device, which includes: an acquiring module, configured to acquire a searching parameter corresponding to the searching request when a searching request sent from a first client is received, when a searching instruction triggered from an information sharing interface displayed by the first client is received, the first client sends the searching request to the server;

a searching module, configured to search in a preset database based on the searching parameter, to obtain the first blacklist information corresponding to the searching parameter;

a verifying module, configured to verify the permission of the first client based on the first blacklist information;

a first sending module, configured to send the first blacklist information to the first client when the verification of the permission of the first client is passed.

Furthermore, the verifying module includes:

an acquiring unit, configured to acquire a first identification information of the first client and a preset authorization information corresponding to the first blacklist information;

a verifying unit, configured to verify the permission of the first client based on the first identification information and the preset authorization information.

Furthermore, the data sharing device includes:

a second sending module, configured to send an authorization request to a sharing client corresponding to the first blacklist information when the verification of the permission of the first client is not passed;

a third sending module, configured to send the first blacklist information to the first client when receiving an agreeing to view message fed back from the sharing client based on the authorization request.

Furthermore, the second sending module includes:

a pushing unit, configured to push an authorization selection interface to the first client when the verification of the permission of the first client is not passed, when receiving an authorization instruction triggered by the authorization selection interface, the first client sends the authorization instruction to the server; and

a sending unit, configured to send the authorization request to the sharing client based on the authorization instruction when receiving the authorization instruction sent from the first client.

The present disclosure also provides a computer-readable storage medium, in the exemplary embodiment, the computer-readable storage medium stores a data sharing program, the data sharing program performs the steps of the data sharing method when executed by a processor.

It should be noted that, in the present application, terms “include”, “comprise” and any other variants thereof are used to cover the non-excludability, so that processes, methods, goods or devices which include a series of elements may include not only these elements, but also other elements that shipping to list clearly, or inherent elements in the processes, the methods, the goods and the devices. In the absence of more restrictions, the elements defined by the statement “includes one . . . ” or other similar are not excluded from the processes, methods, goods or devices of the elements.

Sequence numbers of the forgoing embodiments of the present application are merely used for description and do not represent the advantages and disadvantages of the embodiments.

Through the above description of the embodiments, it is apparent to those skilled in the art that the above-mentioned embodiments may be implemented by software and a necessary universal hardware platform, of course, the hardware may also be used, but in many cases, the former is a better choice. According to this, an essence of the technical solution of the present application or a contribution to the prior technology may be reflected in a form of computer software products, the computer software products may be stored in a storage medium (such as an ROM/RAM, a magnetic disc, a light disc), a number of instructions are included for enabling a mobile terminal to perform the methods in each embodiment of the present application.

The foregoing description merely depicts some illustrative embodiments of the present application and therefore is not intended to limit the scope of the application. An equivalent structural or flow changes made by using the content of the specification and drawings of the present application, or any direct or indirect applications of the disclosure on any other related fields shall all fall in the scope of the application.

1. A data sharing method, comprising:
when a searching request sent from a first client is received, a server acquiring a searching parameter corresponding to the searching request, wherein, when a searching instruction triggered from an information sharing interface displayed by the first client is received, the first client sends the searching request to the server;
the server searching in a preset database based on the searching parameter, to obtain a first blacklist information corresponding to the searching parameter;
the server verifying the permission of the first client based on the first blacklist information; and
when the verification of the permission of the first client is passed, the server sending the first blacklist information to the first client.

2. The data sharing method according to claim 1, wherein the blacklist information comprises seat blacklist information, the data sharing method further comprises:
the server periodically acquiring resume information received by a preset client in a preset time period;
the server matching a preset parameter in the resume information to the seat blacklist information, to acquire the blacklist information in the seat blacklist information matched to the preset parameter; and
the server sending the blacklist information, and the resume information corresponding to the blacklist information to the preset client corresponding to the blacklist information.

3. The data sharing method according to claim 1, wherein the step of the server verifying the permission of the first client based on the first blacklist information, comprises:
the server acquiring a first identification information of the first client and a preset authorization information corresponding to the first blacklist information; and
the server verifying the permission of the first client based on the first identification information and the preset authorization information.

4. The data sharing method according to claim 3, wherein the blacklist information comprises seat blacklist information, the data sharing method further comprises:
the server periodically acquiring resume information received by a preset client in a preset time period;
the server matching a preset parameter in the resume information to the seat blacklist information, to acquire the blacklist information in the seat blacklist information matched to the preset parameter; and
the server sending the blacklist information, and the resume information corresponding to the blacklist information to the preset client corresponding to the blacklist information.

5. The data sharing method according to claim 1, wherein after the step of the server verifying the permission of the first client based on the first blacklist information, the data sharing method further comprises:
when the verification of the permission of the first client is not passed, the server sending an authorization request to a sharing client corresponding to the first blacklist information; and
when an agreeing to view message fed back from the sharing client based on the authorization request is received, the server sending the first blacklist information to the first client.

6. The data sharing method according to claim 5, wherein the blacklist information comprises seat blacklist information, the data sharing method further comprises:
the server periodically acquiring resume information received by a preset client in a preset time period;
the server matching a preset parameter in the resume information to the seat blacklist information, to acquire the blacklist information in the seat blacklist information matched to the preset parameter; and
the server sending the blacklist information, and the resume information corresponding to the blacklist information to the preset client corresponding to the blacklist information.

7. The data sharing method according to claim 5, wherein the step of when the verification of the permission of the first client being not passed, the server sending an authorization request to a sharing client corresponding to the first blacklist information, comprises:
when the verification of the permission of the first client is not passed, the server pushing an authorization selection interface to the first client, wherein, when an authorization instruction triggered by the authorization selection interface is received, the first client sends the authorization instruction to the server; and
when the authorization instruction sent from the first client is received, the server sending the authorization request to the sharing client based on the authorization instruction.

8. The data sharing method according to claim 7, wherein the blacklist information comprises seat blacklist information, the data sharing method further comprises:
the server periodically acquiring resume information received by a preset client in a preset time period;
the server matching a preset parameter in the resume information to the seat blacklist information, to acquire the blacklist information in the seat blacklist information matched to the preset parameter; and
the server sending the blacklist information, and the resume information corresponding to the blacklist information to the preset client corresponding to the blacklist information.

9. The data sharing method according to claim 5, wherein after the step of the server sending an authorization request to a sharing client corresponding to the first blacklist information, the data sharing method further comprises:
when a refusing to view message fed back from the sharing client based on the authorization request is received, the server sending the refusing to view message to the first client;
the server acquiring the first identification information of the first client, the second identification information of the sharing client, a sending time corresponding to the searching request, and a feedback time corresponding to the refusing to view message; and
the server associating and storing the first identification information, the second identification information, the sending time, and the feedback time.

10. The data sharing method according to claim 9, wherein the blacklist information comprises seat blacklist information, the data sharing method further comprises:
the server periodically acquiring resume information received by a preset client in a preset time period;
the server matching a preset parameter in the resume information to the seat blacklist information, to acquire the blacklist information in the seat blacklist information matched to the preset parameter; and
the server sending the blacklist information, and the resume information corresponding to the blacklist information to the preset client corresponding to the blacklist information.

11. The data sharing method according to claim 1, wherein the data sharing method further comprises:
when an uploading request sent from a second client is received, the server acquiring a second blacklist information corresponding to the uploading request and a third identification information corresponding to the second client;
the server associating and storing the second blacklist information and the third identification information; and
the server updating the information sharing interface according to attribute information of the second blacklist information and the third identification information, and sending the updated information sharing interface to a preset client, for the preset client to display the received information sharing interface.

12. The data sharing method according to claim 11, wherein the blacklist information comprises seat blacklist information, the data sharing method further comprises:
the server periodically acquiring resume information received by a preset client in a preset time period;
the server matching a preset parameter in the resume information to the seat blacklist information, to acquire the blacklist information in the seat blacklist information matched to the preset parameter; and
the server sending the blacklist information, and the resume information corresponding to the blacklist information to the preset client corresponding to the blacklist information.

13. The data sharing method according to claim 11, wherein the step of the server associating and storing the second blacklist information and the third identification information comprises:
the server classifying the second blacklist information according to a preset rule; and
the server associating and storing the classified second blacklist information and the third identification information.

14. The data sharing method according to claim 13, wherein the blacklist information comprises seat blacklist information, the data sharing method further comprises:
the server periodically acquiring resume information received by a preset client in a preset time period;
the server matching a preset parameter in the resume information to the seat blacklist information, to acquire the blacklist information in the seat blacklist information matched to the preset parameter; and
the server sending the blacklist information, and the resume information corresponding to the blacklist information to the preset client corresponding to the blacklist information.

15. A data sharing device, comprising one or more processors and a non-transitory program storage medium storing program code executable by the one or more processors, the program code comprising:
an acquiring module, configured to, when a searching request sent from a first client is received, acquire a searching parameter corresponding to the searching request, wherein, when a searching instruction triggered from an information sharing interface displayed by the first client is received, the first client sends the searching request to the server;
a searching module, configured to search in a preset database based on the searching parameter, to obtain a first blacklist information corresponding to the searching parameter;
a verifying module, configured to verify the permission of the first client based on the first blacklist information; and
a first sending module, configured to send the first blacklist information to the first client when the verification of the permission of the first client is passed.

16. The data sharing device according to claim 15, wherein the verifying module comprises:
an acquiring unit, configured to acquire a first identification information of the first client and a preset authorization information corresponding to the first blacklist information; and
a verifying unit, configured to verify the permission of the first client based on the first identification information and the preset authorization information.

17. The data sharing device according to claim 15, wherein the data sharing device further comprises:
a second sending module, configured to send an authorization request to a sharing client corresponding to the first blacklist information when the verification of the permission of the first client is not passed; and
a third sending module, configured to send the first blacklist information to the first client when an agreeing to view message fed back from the sharing client based on the authorization request is received.

18. The data sharing device according to claim 17, wherein the second sending module comprises:
a pushing unit, configured to push an authorization selection interface to the first client by the server when the verification of the permission of the first client is not passed, wherein when an authorization instruction triggered by the authorization selection interface is received, the first client sends the authorization instruction to the server; and
a sending unit, configured to send the authorization request to the sharing client based on the authorization instruction when the authorization instruction sent from the first client is received.

19. A data sharing device, comprising a memory, a processor, and a data sharing program stored in the memory and operated by the processor, the data sharing program performing the following steps in data sharing method when being executed by a processor:
when a searching request sent from a first client is received, a server acquiring a searching parameter corresponding to the searching request, wherein, when a searching instruction triggered from an information sharing interface displayed by the first client is received, the first client sends the searching request to the server;
the server searching in a preset database based on the searching parameter, to obtain a first blacklist information corresponding to the searching parameter;
the server verifying the permission of the first client based on the first blacklist information; and
when the verification of the permission of the first client is passed, the server sending the first blacklist information to the first client.

20. (canceled)
